(19) United States
(12) Patent Application Publication
(10) Pub. No.: US 2011/0125822 A1
(43) Pub. Date: May 26, 2011

(54) SYSTEM, METHOD AND COMPUTER PROGRAM FOR MONITORING PRODUCTION PROCESS DATA

(76) Inventor: Detlev Wasserka, Cambridge (CA)

(21) Appl. No.: 12/625,752

(22) Filed: Nov. 25, 2009

(51) Int. Cl. G06F 15/16

(52) U.S. Cl. 709/201; 709/218; 340/635

(57) ABSTRACT

A system, method and computer program for monitoring production process data from one or more production machines is provided. The system comprises a data communication means linked to each production machine. The data communication means is operable to communicate the process data output by each production machine over a network. The system also comprises a host computer including a network interface. The host computer is operable to collect the process data from the one or more production machines by means of a network link between the data communication means and the network interface. The host computer may further parse and analyze the production data for monitoring the production process.

### FIELD OF THE INVENTION

The present invention relates to manufacturing. The present invention relates more specifically to monitoring production process data.

### BACKGROUND OF THE INVENTION

It is crucial to monitor the plastic injection moulding process and the performance of the injection moulding machine during the production of plastic items. The performance of the machine, and the quality of the produced items, can be evaluated by referring to production parameters, such as injection time, holding time, overall cycle time, screw feeding time, injection speed, injection transfer pressure (at transfer to holding phase), hydraulic hold pressure, hydraulic injection peak pressure, hydraulic back pressure, injection transfer position, cavity pressure, screw feeding position, cushion position, etc.

Typical injection moulding machines incorporate many different types of sensors and a computer control system in order to function and produce a plastic part. Hydraulic pressure sensors, positional sensors, and timers are used to monitor the current conditions of the hydraulics, electrics and the position of machine components and systems.

Data is commonly collected by the machine during the moulding process and is available for printing, viewing or saving to a printer or memory device at the end of each machine cycle. The machine itself may also contain software programs which compare this data every shot and provide “alarming” functions. These programs are most often not used by the machine operators and technicians on the product floor, and are turned off.

Computer monitoring systems have therefore been provided as additional components to monitor the product data. These systems provide process monitoring functions, but they require a number of expensive sensors and additional hardware or software updates for the machine. By not using the machine's existing data and signals, these systems are very expensive and complicated.

U.S. Pat. No. 7,465,417 and U.S. Patent application publication number 20060012064 to Hutson et al. provides a multivariate analysis on injection moulding process data collected real-time and determining whether the real-time data is within a predetermined production control limit. When the real-time production data exceeds the control limit, the process is considered out of control and product produced during the out of control condition is removed real-time from the injection moulding production process. The process data includes injection time, holding time, hydraulic pressure, etc. However, Hutson does not disclose or contemplate collecting such production data using means already present within the production machine.

U.S. Pat. No. 5,301,120 to Magario provides a method for collecting process data from a plurality of injection moulding machines by means of a control computer system incorporated in an LAN. More specifically, the patent relates to the control computer system specifying a collection starting time and a collection terminating time of the data for the respective injection moulding machines and collecting the process data within these periods. Magario, however utilizes a proprietary optical interface for collecting the process data, rather than any already present means within the production machine.

U.S. Pat. No. 6,051,170 to Kamiguchi et al. provides a method of collecting moulding data and obtaining a moulding condition. A rough moulding condition obtained by a condition setting operation is modified with a pitch which is set for respective moulding condition items and a plurality of analogous moulding conditions are created and stored in a host computer. A set of the analogous moulding conditions and the set number of test shots are transferred to a controller of an injection moulding machine to continuously carry out the test shots. Moulding data detected in the test shots are transferred to and stored in the host computer. An optimal moulding condition is obtained by evaluating the moulding data under the respective moulding conditions. In particular, the controller disclosed comprises a CPU for CNC, CPU for PC, a servo CPU and a pressure monitor CPU. Information communicated between the CPUs is transmitted through a bus. However, Kamiguchi does not disclose or contemplate collecting such production data using means already present within the production machine.

The prior art assumes the use of proprietary or “add on” sensors to provide production data. An alternative could be to “tap” into the machine sensors, but this would require an extensive knowledge of the particular machines' wiring schematics, control system, power systems, etc. While most machines can be provided with detailed schematics, re-wiring every machine is very expensive and time consuming and requires a high degree of skill. Furthermore, driving multiple inputs from one sensor may exceed the rated capabilities of a sensor as each connection requires additional power that may damage the sensor. Additionally, each of the actual sensors on the machine provide an analog output (such as from 0 volts to 10 volts), and this signal must be somehow interpreted into a real pressure or position value.

What has not been contemplated is the use of the already existing capabilities of the injection moulding machine and by using the process data available from the machine to provide a much more cost effective solution.

### SUMMARY OF THE INVENTION

The present invention, in one aspect thereof, provides a data acquisition system operable to acquire data from one or more production machines, the production machines operable to provide process data, the system comprising: (a) a data communication means linked to each production machine, the data communication means operable to communicate the process data output by each production machine over a network; and (b) a host computer including a network interface, the host computer operable to collect the process data from the one or more production machines by means of a network link between the data communication means and the network interface.

The present invention, in another aspect thereof, provides a method for collecting process data from one or more production machines, the production machines operable to provide process data, the method comprising: (a) communicating, by means of a data communication means linked to each production machine, the process data output by each production machine to a host computer; and (b) collecting, by means of a network interface linked to the host computer, the process data from the one or more production machines by means of a network link between the data communication means and the network interface.

The present invention, in a further aspect thereof, provides a computer program product comprising computer instructions which, when loaded on one or more computer processors linked to a host computer, are operable to provide a data acquisition system for acquiring data from one or more production machines, the production machines operable to provide process data, wherein the computer program is operable to perform the steps of: (a) communicating, by means of a data communication means linked to each production machine, the process data output by each production machine to a host computer; and (b) collecting, by means of a network interface linked to the host computer, the process data from the one or more production machines by means of a network link between the data communication means and the network interface.

### BRIEF DESCRIPTION OF THE DRAWINGS

FIG. 1 illustrates a system in accordance with the present invention.

FIG. 2 illustrates the collection, monitoring and analysis of cyclic process data.

FIG. 3 illustrates the generation of an alarm notification in one particular example of the present invention.

### DETAILED DESCRIPTION

The present invention provides a system, method and computer program for monitoring production process data. The data is provided by one or more existing production machines as cyclic process data. The present invention is operable to collect, monitor and analyze the data to determine the quality of the parts produced. The production process may include, for example, plastic injection moulding process, plastic blow moulding process, plastic extrusion process and industrial automation process.

As opposed to the prior art approaches whereby proprietary sensors are required, the present invention is implementable using the existing capabilities of the production machines and by using the process data available from the machine to provide a much more cost effective solution. The already available cyclic process data which is normally sent from the machine to a printer is instead routed to a central host computer that collects, monitors and analyzes the process data from one or more multiple production machines simultaneously.

Thus the present invention provides a low cost data acquisition system by utilizing available process data, resulting in reduced scrap, less customer rejections, less sorting of suspect product, accurate quarantine part data, faster production runs and less downtime, faster reaction to machine breakdowns and failing or worn machine components, and records of each production run which can be used to analyze customer complaints or rejections.

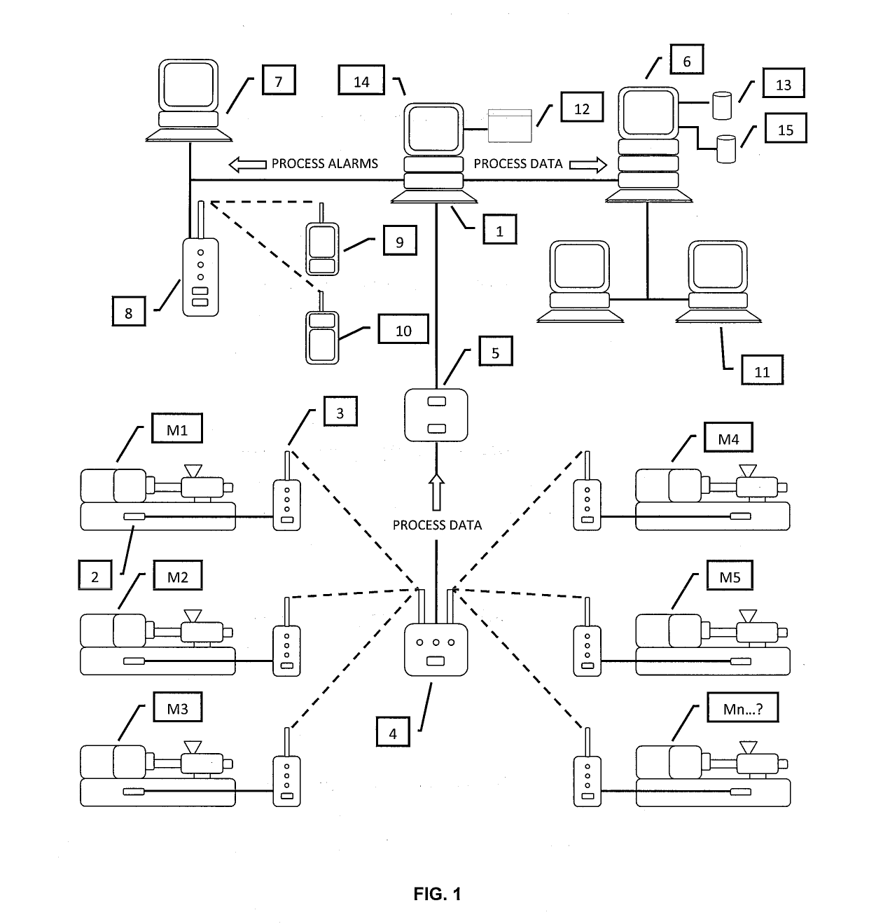

FIG. 1 illustrates a system in accordance with the present invention.

The system may include one or more production machines M1, M2, M3, M4, M5, . . . Mn, each of which is linkable to a central host computer 1 by means of a wired and/or wireless connection. The wired connection may be a network connection, serial interface (for example using RS-232, USB or RS485), parallel interface (for example, a printer port), or other wired communications link. The wireless connection may include a wireless network and one or more wireless network interface means, which may for example utilize Ethernet, Bluetooth or other similarly operable protocols.

In one particular implementation, each production machine is operable to provide cyclic process data via its serial interface 2. Cyclic process data may include one or more production process parameters configured to be communicable via an interface. For example, the parameters could be configured as comma delimited, tab delimited, space delimited or other formatted ASCII string. The parameters may include one or more of: injection time, holding time, overall cycle time, screw feeding time, injection speed, injection transfer pressure (at transfer to holding phase), hydraulic hold pressure, hydraulic injection peak pressure, hydraulic back pressure, injection transfer position, cavity pressure, screw feeding position, cushion position, or other relevant parameter.

A serial to wireless Ethernet communications device 3, such as a wireless network adaptor linked to the serial port of the production machine, may be provided for transforming the cyclic process data to a data stream communicable by Ethernet connection. The cyclic process data is then communicated wirelessly to a wireless access point 4 linked to the host computer 1, which is further linked to the computer program 12 of the present invention.

The computer program 12 is operable to collect the cyclic process data received from the one or more production machines M1, M2, M3, M4, M5, Mn. The cyclic process data may be recorded to a process database 13 linked to the host computer, optionally by means of a server computer 6. The computer program 12 may include a user interface for displaying the cyclic process data on a display means 14, such as a computer monitor, linked to the host computer. Displaying the cyclic process data may enable an operator, technician, or supervisor to evaluate the cyclic process data in real time to form an assessment of the quality of the parts produced.

A server computer 6 may be provided for administering alerts and recording the cyclic process data to the process database 13. In addition, one or more remote computers 11 may be linked to the server computer 6 for remotely displaying the cyclic process data. The remote computers may be configured to view the cyclic process data, by means of an installed application or web application interface, and could be configured to prevent user configuration of the system, including for example changes to tolerances, master process data, machine specifications, etc., each of which are described more fully below. The remote computers may also be enabled to view historical or archived cyclic process data.

The host computer may also be linked, optionally by means of the server computer 6, to a master database 15 comprising master process data and a configurable set of tolerances, against which to compare the collected cyclic process data. In this way, the host computer can determine whether the cyclic process data is acceptable or unacceptable.

The host computer may be operable to provide alarm notifications corresponding to unacceptable cyclic process data. The alarm notifications may be provided, for example, as email notifications and/or SMS text messages. The alarm notifications may, for example, be sent by a manufacturing plant's internal email system or external email system to a computer 7 assigned to the desired recipient or by a GSM modem 8 operable to transmit to a preconfigured mobile telephone or smartphone device 9 or personal digital assistant 10 an alarm text message.

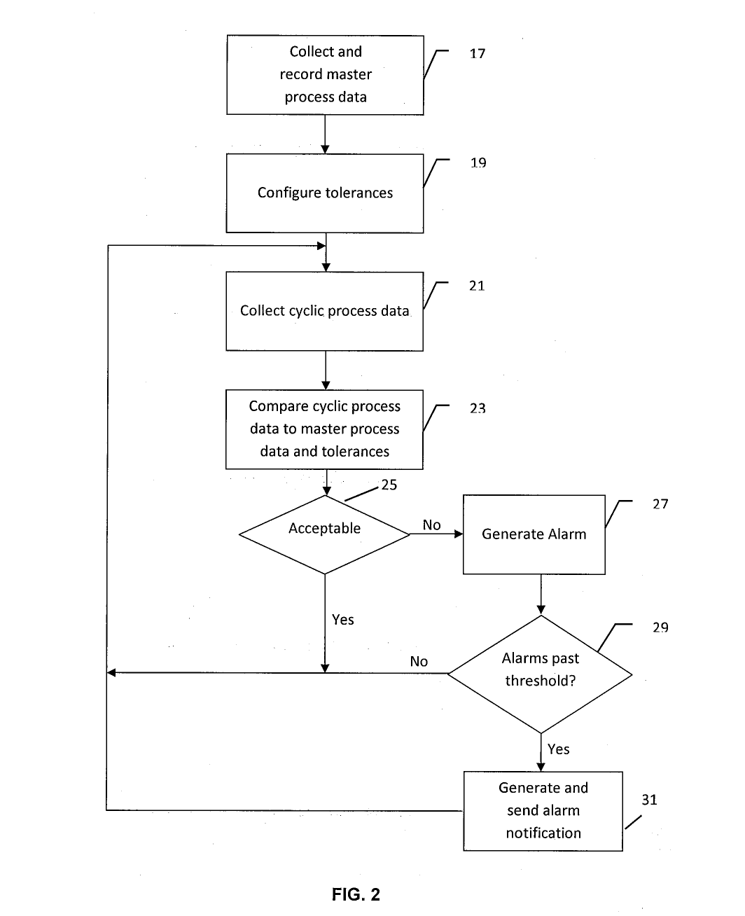

FIG. 2 illustrates the collection, monitoring and analysis of cyclic process data.

Cyclic process data, as previously mentioned, may include parameters corresponding to one or more different times, velocities, pressures and positions, which are measured and optionally recorded by each production machine during manufacturing of parts. This cyclic process data can be used as an indicator of the quality of the produced part and be used to immediately inform plant personnel, by email or text message for example, of the changes in the moulding process which may affect part quality.

Some examples of cyclic process data parameters used in plastics mould injection may include injection time, holding time, overall cycle time, screw feeding time, injection speed, injection transfer pressure (at transfer to holding phase), hydraulic hold pressure, hydraulic injection peak pressure, hydraulic back pressure, injection transfer position, cavity pressure, screw feeding position, cushion position, etc.

Initially or on a periodic or basis, cyclic process data may be collected during known optimum running connections and recorded as “master process data” 17. The master process data may be recorded to the master database. In addition, the computer program user interface may enable a user to configure 19 one or more tolerances corresponding to each parameter. These tolerances may define thresholds around the parameters for evaluating whether produced parts are of acceptable or unacceptable quality.

The computer program may then collect cyclic process data 21 from each production machine, as it is output by each machine at the end of each machine cycle, and compare one or more of the collected cyclic process data parameters against the master process data and tolerances 23.

During the comparison process, if current cyclic process data is determined 25 to fall outside of the set tolerances the corresponding produced parts may be deemed as “unacceptable” or “suspect”, and alarms may be generated 27. The alarms may be recorded and a running count of all alarms may be saved to the process database.

The product machine may be equipped with a wired or wireless input/output means in communication with the host computer. For example, a wireless Ethernet interface, such as an ADAM-6050W™ digital input/output module, may be linked to the production machine and operable to drive an input of the production machine. The input/output means may, for example, be linked to a “reject”, “diversion”, “mould close permit”, “robot”, or “hold” input of the production machine. The host computer, by communication with the input/out means, may redirect unacceptable or suspect parts to an intermediate, or “hold”, location until an assessment of the product quality is determined. For example, a “hold” signal may be sent by the host computer to the production machine. The production machine, when receiving the signal by the input/output means, may be operable to respond to the signal by halting the production process. The production machine may be configured to redirect the corresponding “suspect” parts by a robotic means, such as a robotic arm, or by a moveable chute to a reject container.

Each shot of parts can be linked to specific saved process data which is date and time stamped, to ensure full and accurate containment of suspect or questionable production.

The master database 15 may also enable the configuration of a threshold number of alarms and a recipient for each type of alarm. If more alarms are generated than the threshold number 29 then the alarm notifications, for example emails or text messages, may be generated by the host or server computer and sent 31, by means of an email system or GSM modem to the appropriate recipient, indicating that the production machine is currently running out-of-tolerance and requires attention.

The computer program linked to the host computer may enable configuration of the host computer and/or the production machine. Individual mould setups may be recorded and saved for any number of different injection moulds to be run in the particular IMM. The first time a mould is run in a particular IMM, the user may be required to enter specific information about the product being run on the IMM and initial master data and tolerances may be configured and saved for that particular mould. When the product is run again in the future, the saved configuration may be retrieved, including all of the part information, material, master data, tolerances and mould preventative maintenance counts. A preventative maintenance count may be the number of cycles of the mould produced. The host computer may be operable to email or text message reminders when set counts are reached. If the count is not reached before the end of a production run the current count may be saved and reloaded the next time the particular mould is run.

The computer program may also be operable to display a plurality of screens to users, including for displaying the IMM conditions, cyclic process data from each moulding cycle, graphical forms of historical process data, saved configurations and system configuration screens. For example, the following screens may be provided for the users.

A machine overview screen may display a basic overview of all of the IMMs connected to the host computer and their current status. The status may be “machine running” or “machine down”, for example. If data has been received from the IMM within a specific time period (for example, 3 minutes) the machine may be deemed to be “running”. If data has not been received within the time period, the text may be dimmed to a dark grey indicating that the machine is deemed “down”. Particular text attributes may also be used as a visual indicator of the status, such as green for “running” and red for “down”. The machine status may also reflect an alarm state if the machine is “down”.

If the machine is in an alarm state, an indicator may display whether an alarm email has been sent or not sent. For example, a round indicator light may blink if the machine is currently in alarm and an email has been sent to a user. The alarm state may be reset by enabling a user to press the blinking display.

The machine overview screen, and all other screens, may also enable a user to access the other screens provided by the computer program.

A process display screen may display information regarding the current cyclic process data being collected for the particular machine. The data may be displayed on the screen and, optionally, particular text attributes may also be used as a visual indicator of the status, such as green for “in tolerance” or red for “out of tolerance” of the master process data. The process display screen may also display the last data collected for each parameter; the current setting for the master process data for each parameter; a means for enabling or disabling monitoring for any or all of the parameters; and means for changing units from imperial to metric and vice versa.

The process display screen may also provide a means to initiate configuration of master process data for a new part or new machine. The user may input details of the mould and part being produced by the machine. This data may be saved for future use during following production runs.

Additionally, the process display screen may provide a means for enabling a user to overwrite master process data with currently collected data, such as may be the case for an optimum production run. The current value of the cyclic process data may be saved and displayed as the new master process data, which all following cycles may be compared against, using the current settings for tolerances.

The user may also provide mould details and part information (such as part number, material type and grade, colour, number of cavities, part weight, runner weight, shot weight, mould temperature and dryer temperature) to be saved against the collected cyclic process data.

The user may also be provided with means to change the selected mould (for example, when the machine will be used for another mould); delete a particular mould setup; or delete all process data currently stored in the host computer memory.

A tolerance display screen may enable a user to set and save individual tolerances around each master process data parameter. Each new piece of cyclic process data that enters the system may be compared against the master process data, saved and analyzed to see if the current cyclic process data falls within the configured tolerances. The tolerances may be displayed, and the user may provide different tolerance values.

A process graphs screen may display one or more graphical representations for historical process data. The user may provide a graph time base settings and data time base to configure the displayed graph. The user may also select additional information to be displayed, including for example statistical data such as minimum, maximum, average, range and standard deviation.

A mould preventative maintenance screen may display details regarding the production machine as determined by the computer program. For example, each time a specific mould/part is put into production on a machine, a running count may be recorded of the number of cycles the mould has produced. At a specific number of running cycles, which may be configured by the user, plant personnel may be advised by email or text message alert that a particular mould is in need of preventative maintenance. This may be useful since injection moulds typically require regular cleaning, greasing and disassembly, to inspect for dry or worn mould components.

A machine specification screen may display settings regarding the production machine being used for producing parts. Specific “machine data” may be used for calculations, configuration of screens and unit conversions. “Machine data” may refer to the sizes and/or specifications of the IMM. The “machine data” may be used, for example, to change the units on the screens between metric and imperial, or standard and absolute units of measurement. Examples of types of “machine data” include: screw diameter, maximum screw stroke, maximum injection pressure, maximum hydraulic pressure, and maximum injection rate.

A machine status screen may enable the user to enable or disable key functions of the computer program for each machine. This may be used, for example, during mould trials, testing, machine repair or other exceptional conditions. Furthermore, the screen may also enable the user to: enable or disable the collection, analysis and recording of cyclic process data and/or to enable or disable the provided alarm functions; or to enable or disable email and/or text message notifications.

An email and/or text message configuration page may be provided for assigning email addresses and/or text message identifiers to particular alarm conditions so as to enable alarm notifications to be sent by email or text message. The configuration may include timeframes such that multi-shift plants can assign different recipients for any of the alarm conditions based on the time of day that the alarm condition was sensed. Alternatively, or in addition, alarm notifications can be sent to particular recipients regardless of the time.

An alarms view screen may display to a user the recent alarms that have been generated. Details such as the date and time of the alarm, machine, process variable, high or low, etc. may be displayed.

An alarm control page may enable a user to control when email or text message alarms are generated and sent to alarm recipients. It may include configurations such as the number of alarms per time period required to send an alarm notification, and/or a setting for consecutive alarms whereby if a particular number of alarms occurs sequentially an alarm notification may be sent.

### Example

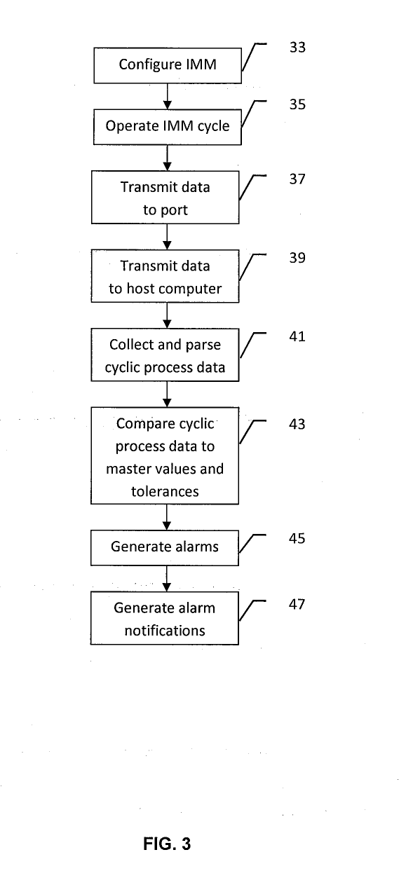

FIG. 3 illustrates the generation of an alarm notification in one particular example of the present invention. In this example the present invention may be implemented as a distributed computer system linked to an injection moulding machine (IMM). The IMM may, for example, be an Engel™ ES330/100TL Injection Moulding Machine (IMM) which is operable to send to its printer port selectable cyclic process data at the end of each moulding cycle. The IMM may, for example, be used to produce a gear used in an automotive throttle body application by employing an eight cavity cold runner using, for example, DuPont™ Delrin™ 500P acetal thermoplastic. It should be readily understood that the IMM, parts and the materials chosen could be any other IMM, parts and materials for which the IMM is operable to send to its printer port selectable process data at the end of each moulding cycle.

A wireless serial server device (WSS) may be linked to the printer port of the IMM. The WSS is operable to communicate the cyclic process data to a wireless access point linked to the host computer.

A modem may be provided for linking the host computer with an internet service provider for enabling email functions of the present invention, and one or more mobile smart phones and cellular service provider accounts may be provided for enabling SMS and/or email functions of the present invention.

The IMM may be configured 33 by means of a configuration utility to provide one or more parameters as cyclic process data. In one example, ten parameters may be provided as cyclic process data, including: injection transfer pressure (psi); peak injection pressure (psi); peak holding pressure (psi); peak back pressure (psi); cushion position (inches); injection transfer position (inches); screw feeding position (inches); injection time (sec); screw feeding time (sec); and cycle time (sec). It should be understood that any other parameters, or fewer parameters, may be selected.

The IMM may also be configured to output the cyclic process data in accordance with a particular output timing and frequency and to output the cyclic process data to the printer port of the IMM at a particular protocol setting (including, for example, baud rate, stop bits, parity and number of data bits). One particular protocol setting may be {9600, 1, no parity, 8}. The IMM may also be configured to provide a particular delimiter to separate the parameters of the cyclic process data including, for example, tab delimited, comma delimited or space delimited.

In accordance with the configuration of the IMM, each cycle in which the IMM produces a “shot” of plastic parts and completes a moulding cycle 35, it will transmit delimited cyclic process data in a delimited data stream out of its printer port 37, comprising the configured parameters. The data stream may end with a termination character, such as a “Vertical Tab” or “Carriage Return” which may be embodied by the codes “\011” or “\013”. An example of such a data stream may be {1025 1054 502 76 0.015 0.023 2.540 0.450 5.56 35.65 011\013}.

The WSS is operable to collect the cyclic process data and transmit it wirelessly to the host computer 39 via the wireless access point. Similarly, a plurality of other production machines, which may be configured similarly or differently with respect to the cyclic process data, may be configured to transmit cyclic process data to the host computer. The host computer is operable to collect, parse, analyse and archive the cyclic process data.

When cyclic process data is detected by the host computer the data may be parsed 41 into individual parameter values and each data point may be saved into their respective machines' individual group of channels by the host computer. The cyclic process data may be parsed based on a configuration linked to the host computer for determining which parameters are present in the cyclic process data. This parameter values may then be saved to the program memory, saved to a file on the hard drive and is then available for further analysis or historical display for a multitude of purposes.

In a particular example of the present invention, a particular mould may be produced by a production machine that comprises a water temperature control unit. An alarm may be provided for production parts that are produced out of tolerance of the master data. Tolerances provided around the master data (which would be dependent on the particular part) may be, for example, +/−50 psi for peak and transfer injection pressure and +/−0.15 inches for cushion position. Additionally, the system may be configured to allow five consecutive alarms or ten alarms in a sixty minute time period before sending an email notification.

The water temperature control unit may pump water through passages of the mould during manufacturing, to cool molten plastic within the mould. The water may be set to a specific temperature dependent upon the material type and the current cycle time.

Production may initially be running within tolerance of the master data, indicating stable process data. The cyclic process data may be collected and analyzed by the host computer, which permits production to continue while the cyclic process data indicates “good” quality.

In a malfunction, the water temperature control unit, for example, may cease to operate due to a blown fuse caused by a failing pump within the unit. Every subsequent cycle after the loss of cooling water will begin to heat the mould higher and higher. This rise in mould temperature may affect several parameters of cyclic process data. For example, injection peak pressure may reduce as the hotter mould allows the plastic to flow into the cavities of the mould easier, requiring less injection pressure during the cycle. Additionally, injection transfer pressure may correspondingly reduce. Furthermore, cushion position may reduce as more plastic is allowed to pack into the mould during injection and holding cycles, again because of the hotter mould surface temperature.

Thus, parts may begin to deform upon ejection out of the mould, because the parts are insufficiently cooled during the cycle. The dimensions of the parts may change since the raised mould temperature may cause increased shrinkages during cooling of the plastic. Additionally, a part may become “stuck” in the mould during ejection and remain in between the mould halves during the next mould close cycle, which in the prior art could cause catastrophic damage to the mould requiring extensive repairs and welding.

As the mould heats, the peak and transfer injection pressure parameters may drop below the allowed tolerance and the host computer may begin to generate and count alarms 45. The cushion position parameter may also drop below the allowed tolerance and the host computer may begin to count alarms.

Since there is no water being pumped through the mould at all, the mould temperature may rise quickly and five consecutive alarms may be reached very quickly, within 15-20 machine cycles, for example. The host computer may send an email notification 47 to a preconfigured recipient, indicating which machine is in alarm and which process parameter(s) is/are out of tolerance. Optionally, the host computer may send a “hold” signal to an input/output means linked to the production machine in order to minimize scrap and simplify quarantining of suspect parts. The signal may cause the production machine to stop cycling at the end of the next cycle.

I claim:

1. A data acquisition system operable to acquire data from one or more production machines, the production machines operable to provide process data, the system comprising:
a) a data communication means linked to each production machine, the data communication means operable to communicate the process data output by each production machine over a network; and
b) a host computer including a network interface, the host computer operable to collect the process data from the one or more production machines by means of a network link between the data communication means and the network interface.

2. The system of claim 1, wherein the process data is cyclic process data.

3. The system of claim 1, wherein the production machine outputs the process data through a serial or parallel port.

4. The system of claim 3, wherein the serial or parallel port is a printer port.

5. The system of claim 1, wherein the host computer is further operable to parse the collected process data.

6. The system of claim 5, wherein the host computer is configurable with a set of master process data and tolerances, and wherein the host computer compares the collected process data to the master process data and tolerances to determine whether the one or more production machines are operating acceptably.

7. The system of claim 3, wherein the data communication means is a serial or parallel to wireless Ethernet communication device.

8. The system of claim 7, wherein the host computer's network interface includes a wireless access point linkable to the data communication means linked to the one or more production machines.

9. The system of claim 6, wherein the host computer is operable to initiate one or more alarm conditions if one or more of the production machines are not operating acceptably.

10. The system of claim 9, wherein the host computer is further operable to initiate one or more alarm notifications corresponding to the alarm conditions sent by email and/or text message to a preconfigured email address and/or mobile device identifier.

11. The system of claim 6, further comprising a server computer linked to a master database for recording the master process data and the tolerances and linked to a process database for recording the process data, wherein the server is remotely accessible by one or more client computers for viewing process data and/or historical process data.

12. The system of claim 1, wherein the one or more production machines are plastic injection moulding machines.

13. A method for collecting process data from one or more production machines, the production machines operable to provide process data, the method comprising:
a) communicating, by means of a data communication means linked to each production machine, the process data output by each production machine to a host computer; and
b) collecting, by means of a network interface linked to the host computer, the process data from the one or more production machines by means of a network link between the data communication means and the network interface.

14. The method of claim 13, wherein the process data is cyclic process data.

15. The method of claim 13, wherein the production machine outputs process data through a serial or parallel port.

16. The method of claim 15, wherein the serial or parallel port is a printer port.

17. The method of claim 13, wherein the host computer is further operable to parse the collected process data.

18. The method of claim 17, wherein the host computer is configurable with a set of master process data and tolerances, and wherein the host computer compares the collected process data to the master process data and tolerances to determine whether the one or more production machines are operating acceptably.

19. The method of claim 15, wherein the data communication means is a serial or parallel to wireless Ethernet communication device.

20. The method of claim 19, wherein the host computer's network interface includes a wireless access point linkable to the data communication means linked to the one or more production machines.

21. The method of claim 18, wherein the host computer is operable to initiate one or more alarm conditions if one or more of the production machines are not operating acceptably.

22. The method of claim 21, wherein the host computer is further operable to initiate one or more alarm notifications corresponding to the alarm conditions sent by email and/or text message to a preconfigured email address and/or mobile device identifier.

23. The method of claim 18, further comprising recording, by means of a server computer linked to a master database, the master process data and the tolerances and, by means of a process database, the process data, wherein the server is remotely accessible by one or more client computers for viewing process data and/or historical process data.

24. The method of claim 13, wherein the one or more production machines are plastic injection moulding machines.

25. A computer program product comprising computer instructions which, when loaded on one or more computer processors linked to a host computer, are operable to provide a data acquisition system for acquiring data from one or more production machines, the production machines operable to provide process data, wherein the computer program is operable to perform the steps of
a) communicating, by means of a data communication means linked to each production machine, the process data output by each production machine to a host computer; and
b) collecting, by means of a network interface linked to the host computer, the process data from the one or more production machines by means of a network link between the data communication means and the network interface.
